(19) United States
(12) Patent Application Publication
(10) Pub. No.: US 2014/0183031 A1
(43) Pub. Date: Jul. 3, 2014

(54) Process for the Treatment of a Recycling Stream from a Plant for the Production of Polyarylene Ether Sulfones

(71) Applicant: BASF SE, Ludwigshafen (DE)

(72) Inventors: Christoph Sigwart, Jeollanam-do (KR); Cornelies Hendricus De Ruiter, Mannhaim (DE); Jörg Erbes, Karlsruhe (DE); Gerhard Lange, Schriesheim (DE); Tobias Kortekamp, Mannheim (DE)

(73) Assignee: BASF SE, Ludwigshafen (DE)

(21) Appl. No.: 14/141,134

(22) Filed: Dec. 26, 2013

Related U.S. Application Data
(60) Provisional application No. 61/746,571, filed on Dec. 28, 2012.

(51) Int. Cl. B01D 3/14

(52) U.S. Cl. CPC B01D 3/148
USPC 203/72; 203/81; 203/74; 203/77

(57) ABSTRACT

A process is proposed for the treatment of a recycling stream (1) from a plant for the production of polyarylene ether sulfones via polycondensation of aromatic bishalogen compounds and of aromatic bisphenols or their salts in the presence of at least one alkali metal carbonate or ammonium carbonate or alkali metal hydrogencarbonate or ammonium hydrogencarbonate in an N-alkyl-2-pyrrolidone as solvent, comprising

from 60 to 90% by weight of water,
from 10 to 40% by weight of the N-alkyl-2-pyrrolidone and, as contaminant detrimental to specification, up to 5000 ppm by weight of the N-alkylsuccinimide corresponding to the N-alkyl-2-pyrrolidone and, alongside this, up to 1000 ppm by weight of other substances with higher boiling point than the N-alkyl-2-pyrrolidone, in particular inorganic salts, based in each case on the total weight of the recycling stream (1), where the entirety of the components gives 100% by weight,
giving a pure N-alkyl-2-pyrrolidone stream (2) which can be returned to the plant for the production of polyarylene ether sulfones, via a final distillation process in a final column (K), wherein the final distillation is preceded upstream by a preliminary purification via evaporation in one or more evaporator stages for reduction of the content of high boilers compared to N-alkyl-2-pyrrolidone, giving one or more vapor streams (4, 5) which are fed as feed streams to the final column (K), the bottom stream (6) from the last evaporator stage being discharged and a substream (9) of the bottom stream (7) from the final column (K) being discharged and the rest of the bottom stream from the final column (K) being recycled into the last evaporator stage, and
the one evaporator stage or the first of the plurality of evaporator stages being a column (WK) which is designed such that the top stream (10) therefrom still comprises a maximum of 200 ppm by weight of the N-alkyl-2-pyrrolidone, based on the total weight of the top stream therefrom, and is discharged, and
the vapor streams (4, 5) being supplied to the final column (K) in vaporous form.

### CROSS-REFERENCE TO RELATED APPLICATIONS

This application claims the benefit of U.S. Provisional Application 61/746,571, filed Dec. 28, 2012, which is incorporated herein by reference.

The invention relates to a process for the treatment of a recycling stream from a plant for the production of polyarylene ether sulfones via polycondensation of aromatic bishalogen compounds and of aromatic bisphenols or their salts in the presence of at least one alkali metal carbonate or ammonium carbonate or alkali metal hydrogencarbonate or ammonium hydrogencarbonate in an N-alkyl-2-pyrrolidone as solvent.

Polyarylene ether sulfones are known with trademark Ultrason® from BASF SE and comprise in particular polyether sulfones (Ultrason® E), polysulfones (Ultrason® S) and polyphenyl sulfones (Ultrason® P).

Ultrason® E, Ultrason® S, and Ultrason® P are transparent plastics with high temperature resistance. They are used in many applications in engineering and in the electrical/electronics sector. There are also numerous reasons for a use as replacement for glass, metal, ceramic, and porcelain in the food-and-drinks sector and household sector: heat resistance extending to 180° C. or short periods at 220° C., good mechanical properties and high breakage resistance, resistance to superheated steam, and excellent resistance to chemicals.

Ultrason® E, S, and P are amorphous thermoplastic polymers with the following underlying structure:

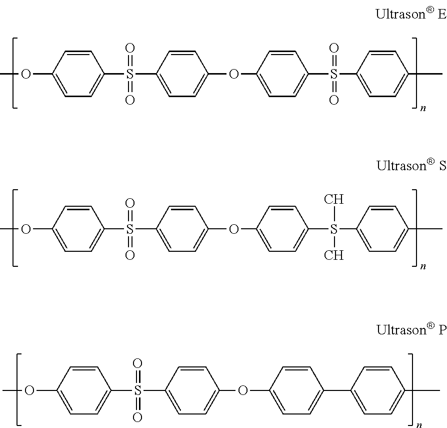

Moldings made of Ultrason® not only have high dimensional stability but also strength, stiffness, and toughness, these properties extending to the vicinity of the glass transition temperature.

The most important features of Ultrason® are:
properties independent of temperature
very high long-term service temperatures
good dimensional stability
high stiffness
high mechanical strength
good electrical insulation capability
advantageous dielectric properties
very advantageous fire performance
exceptional resistance to hydrolysis.

The three Ultrason® parent polymers are amorphous thermoplastics and are transparent. However, by virtue of the high temperatures required during their production and processing they have a certain intrinsic color (pale golden yellow to ocher) which prevents achievement of the theoretically possible transmittance values for visible light. The qualities achievable currently are nevertheless suitable for very many transparent applications. Ultrason® also has high refractive indices in the visible wavelength region, and it therefore has another use in functional optical applications, for example lenses for electronic cameras.

Polyarylene ether sulfones are frequently produced via polycondensation in the presence of, as polar aprotic solvent, an N-alkyl-2-pyrrolidone, hereinafter abbreviated to NAP. N-methyl- or N-ethylpyrrolidone are particular N-alkyl-2-pyrrolidones used, and preferably N-methylpyrrolidone is used. Processes of this type are disclosed by way of example in U.S. Pat. No. 4,870,153, EP-A 113 112, EP-A 297 363, and EP-A 135 130.

Contaminated solvent arises in the above processes, and for economic and environmental reasons has to be treated and recycled into the process.

However, the solvent used in the above processes has to comply with the criteria for what is known as pure NAP, i.e. at least 99.0% by weight NAP content or else at least 99.5% by weight NAP content, or else at least 99.8% by weight NAP content, based in each case on the total weight of the pure NAP stream, and at most the following contents of components detrimental to specification: 0.1% by weight of water and 0.02% by weight of N-alkylsuccinimide or else 0.01% by weight of N-alkylsuccinimide, hereinafter abbreviated to NAS, based in each case on the total weight of the pure NAP stream.

Higher NAS contents in the NAP solvent have a disadvantageous effect on the color of the polyarylene ether sulfone, which is the useful product. This is surprising because not only NAP itself but also NAS, which can be produced by way of example via oxidation of NAP by atmospheric oxygen, are colorless substances. However, for the reasons described the market demands polyaryl ether sulfones with minimized intrinsic color.

Current thinking in relation to polyarylene ether sulfone production with NAP as solvent is that there is a causal connection between the NAS produced via oxidation of the NAP, for example the N-methylsuccinimide (NMS) produced via oxidation of

N-methylpyrrolidone (NMP):

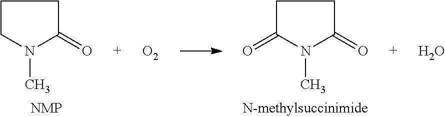

and the undesired intrinsic color of the final polyarylene ether sulfone product.

It is believed that NAS is a precursor for higher-molecular-weight colorant components which impair the intrinsic color of the final polyarylene ether sulfone product.

Before NAP-containing recycling streams are recycled into the production of polyarylene ether sulfone, they are therefore purified by final distillation in a traditional distillation column sufficiently to give a pure NAP complying with the criteria defined above.

CN 2007 100 39497 discloses a process for the reclamation of NMP as solvent from the polycondensation process to give para-phenyleneterephthalamide, where the polymer is washed with deionized water, the wash solution is neutralized with a carbonate, oxide or hydroxide of an alkali metal or of an alkaline earth metal, and in two thin-film evaporators, at a pressure of from 0.1 to 3.0 bar absolute and at a temperature of from 90 to 120° C. is subjected to initial distillation, and also then to final distillation, giving a pure NMP stream with purity higher than 99.5% and with water content below 100 ppm which is suitable for return into the polycondensation plant for the production of polymerizable para-phenyleneterephthalamides.

When a conventional procedure, without preliminary evaporation, is used the heat exchanger for the bottom stream from the distillation column for pure NAP becomes blocked by contaminants after only a short time, and said plant therefore requires frequent shutdown for heat exchanger cleaning.

### BRIEF DESCRIPTION OF THE DRAWING

FIG. 1 shows a diagram of a preferred plant for carrying out the process of the invention.

### DETAILED DESCRIPTION OF THE INVENTION

In the light of this, it was an object of the invention to provide a process for the treatment of recycling streams from polyarylene ether sulfone processes via distillation to give pure NAP which can be recycled into the plant for carrying out a polyarylene ether sulfone process, where the process reliably provides an increased operation time of the distillation column and moreover minimizes required apparatus cost and energy cost, and where NAP losses are minimized.

A particular intention is for the proportion of water in the recycling stream to be treated to be already greatly reduced at the start of the process such that the downstream apparatuses can be smaller.

The object is achieved via a process for the treatment of a recycling stream from a plant for the production of polyarylene ether sulfones via polycondensation of aromatic bishalogen compounds and of aromatic bisphenols or their salts in the presence of at least one alkali metal carbonate or ammonium carbonate or alkali metal hydrogencarbonate or ammonium hydrogencarbonate in an N-alkyl-2-pyrrolidone as solvent, comprising
from 60 to 90% by weight of water,
from 10 to 40% by weight of the N-alkyl-2-pyrrolidone and, as contaminant detrimental to specification, up to 5000 ppm by weight of the N-alkylsuccinimide corresponding to the N-alkyl-2-pyrrolidone and, alongside this, up to 1000 ppm by weight of other substances with higher boiling point than the N-alkyl-2-pyrrolidone, in particular inorganic salts, based in each case on the total weight of the recycling stream, where the entirety of the components gives 100% by weight,
giving a pure N-alkyl-2-pyrrolidone stream which can be returned to the plant for the production of polyarylene ether sulfones, via a final distillation process in a final column, wherein the final distillation is preceded upstream by a preliminary purification via evaporation in one or more evaporator stages for reduction of the content of high boilers compared to N-alkyl-2-pyrrolidone, giving one or more vapor streams which are fed as feed streams to the final column (K), the bottom stream from the last evaporator stage being discharged and a substream of the bottom stream from the final column (K) being discharged and the rest of the bottom stream from the final column (K) being recycled into the last evaporator stage, and the one evaporator stage or the first of the plurality of evaporator stages being a column (WK) which is designed such that the top stream therefrom still comprises a maximum of 200 ppm by weight of the N-alkyl-2-pyrrolidone, based on the total weight of the top stream therefrom, and is discharged, and
the vapor streams being supplied to the final column (K) in vaporous form.

It has been found to be possible to treat recycling streams from the production of polyarylene ether sulfones in a manner which is advantageous in terms of apparatus and of energy to give pure NAP, by virtue of the final distillation in a conventional distillation column being preceded upstream by a preliminary purification by evaporation, in which the content of salts in the recycling stream is reduced in one or more evaporator stages.

The N-alkyl-2-pyrrolidone is preferably selected from N-methyl- and N-ethylpyrrolidone. It is particularly preferable for the N-alkyl-2-pyrrolidone used to be N-methylpyrrolidone (hereinafter abbreviated to NMP).

The recycling stream preferably comprises from 60 to 90% by weight of water, from 10 to 40% by weight of the N-alkyl-2-pyrrolidone and, as contaminant detrimental to specification, up to 1000 ppm by weight of the N-methylsuccinimide corresponding to the N-alkyl-2-pyrrolidone and, alongside this, up to 300 ppm by weight of other substances with higher boiling point than the N-alkyl-2-pyrrolidone, in particular inorganic salts, based in each case on the total weight of the recycling stream, where the entirety of the components gives 100% by weight.

Particularly preferably, the recycling stream comprises from 60 to 90% by weight of water,
from 10 to 40% by weight of NMP and, as contaminant detrimental to specification, up to 1000 ppm by weight of NMS and, alongside this, up to 300 ppm by weight of other substances with higher boiling point than NMP, in particular inorganic salts, based in each case on the total weight of the recycling stream, where the entirety of the components gives 100% by weight.

Further preferably, the recycling stream comprises from 70 to 85% by weight of water, from 20 to 25% by weight of the N-alkyl-2-pyrrolidone and, as contaminant detrimental to specification, up to 300 ppm of the N-methylsuccinimide corresponding to the N-alkyl-2-pyrrolidone and, alongside this, up to 50 ppm by weight of other substances with higher boiling points than the N-alkyl-2-pyrrolidone, in particular inorganic salts, based in each case on the total weight of the recycling stream, where the entirety of the components gives 100% by weight.

In particular, the recycling stream comprises from 70 to 85% by weight of water, from 20 to 25% by weight of NMP and, as contaminant detrimental to specification, up to 300 ppm by weight of NMS and, alongside this, up to 50 ppm by weight of other substances with higher boiling point than the N-alkyl-2-pyrrolidone, in particular inorganic salts, based in each case on the total weight of the recycling stream, where the entirety of the components gives 100% by weight.

The recycling stream in the process according to the invention is purified to give a pure NAP stream which meets the criteria defined at the outset with regard to the NAP content, i.e. an NAP content of at least 99.0% by weight, or else of at least 99.5% by weight or else of at least 99.8% by weight, based in each case on the total weight of the pure NAP stream, and, with regard to the components detrimental to specification, not more than 0.1% by weight of water and not more than 0.2% by weight of N-alkylsuccinimide, or else not more than 0.01% by weight of N-alkylsuccinimide, abbreviated hereinafter to NAS, based in each case on the total weight of the pure NAP stream.

For the evaporation, preferably two or three evaporator stages are provided.

According to the invention, the first evaporator stage takes the form of a column. The column can be referred to as a water column, since it is designed such that the predominant proportion, especially of from 70 to 90%, of the water present in the recycling stream is drawn off via the vapor stream thereof.

For this purpose, the column is designed especially with from 2 to 20, preferably with from 5 to 15, theoretical plates, a top temperature in the range from 250 mbar absolute to standard pressure and a top temperature of from 60 to 100° C.

Further preferably, the first column is operated at a top pressure in the range from 300 to 800 mbar absolute.

In this case, the top stream from the column still comprises a maximum of 100 ppm by weight of NAP, based on the total weight of the top stream therefrom, preferably still comprises a maximum of 50 ppm by weight of NAP, based on the total weight of the top stream therefrom.

The second evaporator stage is preferably operated at a pressure in the vapor space in the range from 250 to 500 mbar absolute, in such a way that most, in particular from 90 95%, of the NAP, in particular NMP, comprised in the recycling stream is drawn off by way of the vapor stream from the second evaporator stage, this stream being introduced as feed stream to the final column.

The second evaporator stage is advantageously operated at a pressure in the vapor space in the range from 300 to 400 mbar.

The third evaporator stage is preferably operated at a pressure in the vapor space in the range from 100 to 400 mbar.

The third evaporator stage is advantageously operated at a pressure in the vapor space in the range from 100 to 200 mbar.

It is particularly preferable to use a thin-film evaporator as evaporator in the third evaporation stage. This is less susceptible to crusting by deposits.

The vapor stream from the second evaporator stage is advantageously introduced into the final column above the vapor stream from the third evaporator stage.

The bottom stream from the final column is preferably entirely returned to the feed of the third evaporator stage.

The recycling stream is frequently composed of plurality of substreams arising in plants for the production of polyarylene ether sulfones, in particular as described in WO 2007/147759, primarily during the use of water for polymer precipitation and, alongside this, also in salt separation and exhaust gas scrubbing.

The final column is preferably operated at an overhead pressure at which it is still possible to use river water for cooling at the top of the column, in particular at an overhead pressure in the range from 100 to 300 mbar absolute.

The bottom temperature in the final column is adjusted to from 150 to 180° C., preferably to about 160 to 170° C., so that the bottom stream still comprises about 0.5 to 10% by weight of NAS, in particular still comprises about 1 to 5% by weight of NAS.

Pure NAS is drawn off as side stream from the final column, preferably from the stripping section thereof, in particular in the form of vapor.

The invention is explained in more detail below with reference to a drawing, and also to an inventive example:

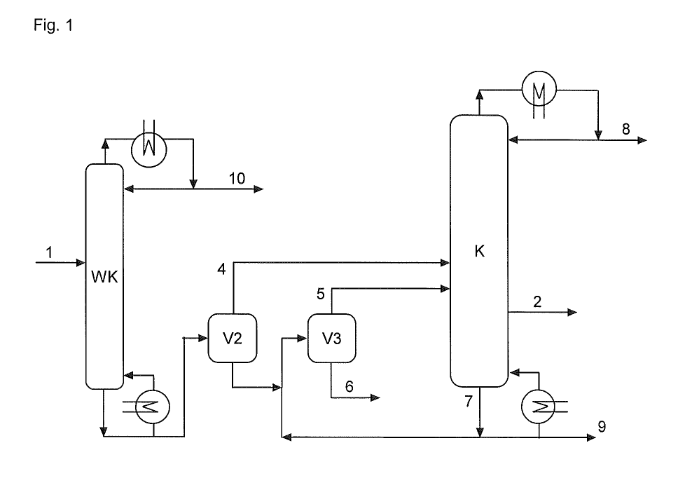

The single figure, FIG. 1, is a diagram of a preferred plant for carrying out the process.

A NMP-containing recycling stream 1 is introduced into the first evaporator stage, which takes the form of column WK, i.e. a distillation column, and from which a vapor stream 10 predominantly comprising water is drawn off and discharged. The bottom stream from the column WK is introduced into the second evaporator stage V2; from this a vapor stream 4 is drawn off and introduced as feed stream into the final column K.

The bottom stream from the second evaporator stage V2 is introduced into the third evaporator stage V3. From this, a further vapor stream 5 is drawn off and is introduced, as further feed stream, into the final column K.

A salt-containing bottom stream 6 is discharged from the third evaporator stage V3. The following are drawn off from the final column K: a pure NMP stream 2, as side stream, a bottom stream 7, part of which is discharged as stream 9, and the rest of which is recycled into the third evaporator stage V3, and also an overhead stream 8 which predominantly comprises water and which is sent for disposal.

### Inventive Example:

The Aspen® simulation program from Aspen Technology Inc. was used to simulate a process for the treatment of a recycling stream 1 for a plant corresponding to the diagram in FIG. 1, whereupon the values listed in the table below are obtained for the composition of the streams.

The following distillation conditions were assumed:

For the water column WK having 10 theoretical plates, an overhead pressure of 500 mbar absolute and an overhead temperature of 81° C., for the second evaporator stage V2 a pressure of 350 mbar absolute and a temperature of 149° C., for the third evaporator stage V3 a pressure of 150 mbar absolute and a temperature of 153° C., and for the final column K an overhead pressure of 197 mbar absolute and a temperature of 60° C. at the top of the column, or else a pressure of 337 mbar absolute and a bottom temperature of 164° C.

As can be seen from the table, NMP loss across the entire process is 1.35% (based on NMP introduced into the process by way of the recycling stream 1). NMS content in the pure NMP stream 2 is only 44 ppm by weight. NMP loss via the vapor stream of the water column WK is only 3 ppm by weight.

| | | | | | Overhead | | Bottom | | | | | |
|---|---|---|---|---|---|---|---|---|---|---|---|---|
| | | | Pure NMP | | stream 8 | | stream 6 | | Bottom | | Overhead | |
| | | | stream 2 (side | | from | | from third | | stream 9 | | stream 10 | |
| | Recycling | | outlet) from final | | final | | evaporator | | from final | | from water | |
| | stream 1 | | column K | | column K | | stage V3 | | column K | | column WK | |
| | kg/h | % | kg/h | % | kg/h | % | kg/h | % | kg/h | % | kg/h | % |
| H₂O | 719.5 | 71.9 | 0.0 | 0.0 | 20.0 | 99.8 | 0.0 | 0.0 | 0.0 | 0.0 | 699.2 | 100.0 |
| KCl | 0.6 | 0.1 | 0.0 | 0.0 | 0.0 | 0.0 | 0.6 | 34.2 | 0.0 | 0.0 | 0.0 | 0.0 |
| NMP | 279.8 | 28.0 | 276.0 | 100.0 | 0.0 | 0.2 | 1.2 | 65.7 | 2.6 | 96.8 | 0.0 | 0.0 |
| NMS | 0.100 | 0.01 | 0.012 | 0.0044 | 0.0 | 0.0 | 0.002 | 0.01140 | 0.086 | 3.2150 | 0.0 | 0.0 |
| Total | 1000 | 100.0 | 276.0 | 100.0 | 20.1 | 100.0 | 1.8 | 100.0 | 2.7 | 100 | 699.2 | 100.0 |

| | |
|---|---|
| NMP loss | 1.35% |

1.-16. (canceled)

17. A process for the treatment of a recycling stream from a plant for the production of polyarylene ether sulfones via polycondensation of aromatic bishalogen compounds and of aromatic bisphenols or their salts in the presence of at least one alkali metal carbonate or ammonium carbonate or alkali metal hydrogencarbonate or ammonium hydrogencarbonate in an N-alkyl-2-pyrrolidone as solvent, comprising
from 60 to 90% by weight of water,
from 10 to 40% by weight of the N-alkyl-2-pyrrolidone and, as contaminant detrimental to specification, up to 5000 ppm by weight of the N-alkylsuccinimide corresponding to the N-alkyl-2-pyrrolidone and, alongside this, up to 1000 ppm by weight of other substances with higher boiling point than the N-alkyl-2-pyrrolidone, based in each case on the total weight of the recycling stream, where the entirety of the components does not exceed 100% by weight,
giving a pure N-alkyl-2-pyrrolidone stream which can be returned to the plant for the production of polyarylene ether sulfones, via a final distillation in a final column, wherein the final distillation is preceded upstream by a preliminary purification via evaporation in one or more evaporator stages for reduction of the content of high boilers compared to N-alkyl-2-pyrrolidone, giving one or more vapor streams which are fed as feed streams to the final column, the bottom stream from the last evaporator stage being discharged and a substream of the bottom stream from the final column being discharged and the rest of the bottom stream from the final column being recycled into the last evaporator stage, and
the one evaporator stage or the first of the plurality of evaporator stages being a column which is designed such that the top stream therefrom still comprises a maximum of 200 ppm by weight of the N-alkyl-2-pyrrolidone, based on the total weight of the top stream therefrom, and is discharged, and
the vapor streams being supplied to the final column in vaporous form.

18. The process according to claim 17, wherein the pure N-alkyl-2-pyrrolidone comprises a maximum of 0.02% by weight of the corresponding N-alkyl succinimide.

19. The process according to claim 18, wherein the pure N-alkyl-2-pyrrolidone comprises a maximum of 0.01% by weight of the corresponding N-alkyl succinimide.

20. The process according to claim 17, wherein the top stream from the column still comprises not more than 100 ppm by weight of the N-alkyl-2-pyrrolidone, based on the total weight of the top stream therefrom.

21. The process according to claim 20, wherein the top stream from the column still comprises a maximum of 50 ppm by weight of the N-alkyl-2-pyrrolidone, based on the total weight of the top stream therefrom.

22. The process according to claim 17, wherein the recycling stream comprises
from 60 to 90% by weight of water,
from 10 to 40% by weight of the N-alkyl-2-pyrrolidone and, as contaminant detrimental to specification, up to 1000 ppm by weight of the N-alkylsuccinimide corresponding to the N-alkyl-2-pyrrolidone and, alongside this, up to 300 ppm by weight of other substances with higher boiling point than the N-alkyl-2-pyrrolidone based in each case on the total weight of the recycling stream (1), where the entirety of the components does not exceed 100% by weight.

23. The process according to claim 22, wherein the recycling stream comprises
from 75 to 80% by weight of water,
from 20 to 25% by weight of the N-alkyl-2-pyrrolidone and, as contaminant detrimental to specification, up to 300 ppm by weight of the N-alkylsuccinimide corresponding to the N-alkyl-2-pyrrolidone and, alongside this, up to 50 ppm by weight of other substances with higher boiling point than the N-alkyl-2-pyrrolidone, in particular inorganic salts, based in each case on the total weight of the recycling stream, where the entirety of the components does not exceed by weight.

24. The process according to claim 17, wherein the N-alkyl-2-pyrrolidone is N-methylpyrrolidone or N-ethylpyrrolidone.

25. The process according to claim 17, wherein the column is operated at a top pressure in the range from 250 mbar absolute to standard pressure, in such a way that the predominant portion of 70 to 90% of the water present in the recycling stream is drawn off from the column via the vapor stream.

26. The process according to claim 17, wherein the water column is operated at a top pressure in the range from 300 to 800 mbar absolute.

27. Process according to claim 17, wherein the second evaporator stage is operated at a pressure in the vapor space in the range from 250 to 500 mbar absolute, in such a way that the predominant portion of 90 to 95% of the N-alkyl-2-pyrrolidone present in the recycling stream is drawn off from the second evaporator stage via the vapor stream which is supplied as feed stream to the final column.

28. The process according to claim 27, wherein the second evaporator stage (V2) is operated at a pressure in the vapor space in the range from 300 to 400 mbar absolute.

29. The process according to claim 17, wherein the third evaporator stage is operated at a pressure in the vapor space in the range from 100 to 400 mbar absolute.

30. The process according to claim 29, wherein the third evaporator stage is operated at a pressure in the vapor space in the range from 100 to 200 mbar absolute.

31. The process according to claim 17, wherein the evaporator used in the third evaporator stage is a thin-layer evaporator.

32. The process according to claim 17, wherein the vapor stream from the second evaporator stage is fed to the final column above the vapor stream from the third evaporator stage.

33. The process according to claim 24, wherein the N-alkyl-2-pyrrolidone is N-methylpyrrolidone.
